(19) United States
(12) Patent Application Publication
(10) Pub. No.: US 2017/0275194 A1
(43) Pub. Date: Sep. 28, 2017

(54) METHOD FOR ADVANCED TREATMENT AND REUSE OF BIOCHEMICAL EFFLUENT FROM CHEMICAL WASTEWATER

(71) Applicants: NANJING UNIVERSITY, Nanjing (CN); NANJING UNI & YANCHENG ACAD OF ENVIRON PROTECT TECH AND ENGINEER, Yancheng (CN)

(72) Inventors: Qing ZHOU, Nanjing (CN); Jing JIN, Nanjing (CN); Aimin LI, Nanjing (CN); Linzhen XU, Nanjing (CN); Jiade CHENG, Nanjing (CN); Weiwei ZHOU, Yancheng (CN); Tianyu FENG, Nanjing (CN); Yan HUANG, Nanjing (CN); Wei WANG, Nanjing (CN)

(21) Appl. No.: 15/619,458

(22) Filed: Jun. 10, 2017

(30) Foreign Application Priority Data
Apr. 11, 2017 (CN) 201710232216.4

(51) Int. Cl. C02F 9/00

(52) U.S. Cl. CPC C02F 9/00; C02F 2305/026; C02F 2303/04; C02F 2101/30

(57) ABSTRACT

A method for advanced treatment and reuse of biochemical effluent from chemical wastewater comprises following steps: (1) preparing a highly-loaded Fe₃O₄ magnetic resin by spray suspension polymerization; (2) using the magnetic resin prepared in Step (1) for advanced treatment of the biochemical effluent from chemical wastewater and adding 3˜5 mmol/L H₂O₂ into the biochemical effluent from chemical wastewater for a mixed reaction of 60˜600 minutes; (3) separating solid from liquid firstly in the mixed wastewater after being treated in Step (2), and then disinfecting the separated biochemical effluent from chemical wastewater.

This application claims priority to Chinese Patent Application Ser. No. CN201710232216.4 filed on 11 Apr. 2017.

### TECHNICAL FIELD

The present invention relates to the field of industrial wastewater treatment technology, more particularly, to a method for advanced treatment and reuse of biochemical effluent from chemical wastewater.

### BACKGROUND

Chemical industry is one of the pillar industries in our country, but environmental pollution caused by this industry is very serious. It is shown from the environmental statistics annual report in recent years that chemical wastewater discharge firmly ranked in the top three industrial wastewater discharge. More importantly, the chemical wastewater not only has a large volume, but also contains many organic matters with strong toxicity, which are difficult for degradation and thus gained much attention nowadays. After biochemical treatment for chemical wastewater, COD and other indexes are difficult to meet the standard for discharging, thus usually advanced treatment technologies are needed. Although conventional process such as coagulation, can decrease COD to some extent, the high toxic substances are hard to be effectively removed. These organic toxic substances contribute little to comprehensive index such as COD and ammonia nitrogen, but they can cause damage to the ecological environment and human health due to their properties of carcinogenic, teratogenic, mutagenic and genotoxicity as they discharge into the ecological system with the wastewater.

Since the organic matters in biochemical effluents are hard to be degraded, advanced oxidation technology is often used as one of the advanced treatment technologies. Among them, Fenton Technology is the most mature advanced oxidation technology, but a lot of iron sludges produced by it have become a bottleneck limiting its technical application. For this actual problem, researchers improve the original homogeneous reaction into heterogeneous reaction, utilizing a carrier to immobilize the ferrous ions and reducing the iron ions in solution through recycling the carrier after throwing into reaction for final reduction of the iron sludge. Also, some researchers use directly magnetic nano iron tetrachloride (Fe₃O₄) as the catalyst for Fenton reaction, and recycle the nanoparticles to reduce the iron sludge in the end. However, Fenton oxidation technology cannot entirely carbonize the organic matter. Instead, it can easily produce intermediate products or by-products with different structures and even some intermediate products are more toxic than the original substances. With regard to this, Fenton oxidation should be combined with other technologies n for effective treatment of the biochemical effluent from chemical wastewater.

### SUMMARY

The purpose of the present invention is to provide a method for advanced treatment and reuse of biochemical effluent from chemical wastewater, which can both effectively remove the organic substances hard to be degraded in biochemical effluent from chemical wastewater, and impair the toxicity for finally meeting the quality standard of reuse water and requirement of security.

In order to solve above technical problems, the present invention uses the following technical solutions:

A method for advanced treatment and reuse of biochemical effluent from chemical wastewater comprises following steps:

(1) preparing a highly-loaded Fe₃O₄ magnetic resin by spray suspension polymerization;

(2) using the magnetic resin prepared in Step (1) for advanced treatment of the biochemical effluent from chemical wastewater and adding 3˜5 mmol/L H₂O₂ into the biochemical effluent from chemical wastewater for a mixed reaction of 60˜600 minutes;

(3) separating solid from liquid firstly in the mixed wastewater after being treated in Step (2), and then disinfecting the separated biochemical effluent from chemical wastewater.

Further, the volume ratio of the magnetic resin to the biochemical effluent from chemical wastewater is 0.1%˜5%.

Further, the specific surface area of the magnetic resin is 500˜700 m²/g, the mass fraction of Fe₃O₄ nanoparticles in the magnetic resin is 30%˜50%.

Further, the magnetic resin is prepared by using a nozzle with aperture of 20˜50 μm to disperse uniformly a mixed solution of an oil phase and Fe₃O₄ nanoparticles into a water phase under 0.1 MPa to form an emulsion, heating up to 70° C. for 2 hours' reaction at a stirring speed of 150 r/min and then heating up to 85° C. for 12 hours' reaction, subsequently using deionized water, ethanol, acetone to wash, and finally drying.

Further, in the oil phase, the monomer is divinylbenzene, the porogen is toluene and the initiator is azobisisobutyronitrile, the ratio of divinylbenzene to toluene is 1:2˜1:3 and the mass fraction of azobisisobutyronitrile is 1%.

Further, in the water phase, the dispersant is sodium dodecyl sulfate and polyvinylpyrrolidone, and the ratio of sodium dodecyl sulfate to polyvinylpyrrolidone is 1:3˜1:6, the mass fraction of the dispersant is 0.5%˜2%.

Further, the Fe₃O₄ nanoparticles is oleic-coated modified, the mass ratio of the Fe₃O₄ nanoparticles and the oil phase is 1:1˜1:2.

Further, in the advanced treatment process, the pH value of the mixed wastewater is adjusted to 5˜7 using hydrochloric acid and sodium hydroxide.

Further, the disinfection is UV and chlorine combined disinfection, being an ultraviolet light and a NaClO disinfectant; the amount of the NaClO disinfectant is 5 mg/L in terms of Cl₂, the ultraviolet light with low pressure mercury lamp as light resource has a UV radiation intensity of 30 W and reaction time of 100˜1800 seconds.

Furthermore, it further comprises mixing the magnetic resin separated from Step (3) with a recycled liquid, which is composed of 5 wt. %˜15 wt. % sodium hydroxide (NaOH), 20 wt. %˜70 wt. % methanol (CH3OH) or 5 wt. %˜15 wt. % NaOH, 50 wt. % CH3OH, after mixing the magnetic resin with the recycled liquid for 20˜180 minutes, standing for 55˜65 minutes to separate the magnetic resin for recycling.

The method for advanced treatment and reuse of biochemical effluent from chemical wastewater provided by above technical solution comprises following beneficial effects:

(1) Using resin absorption material to immobilize Fe₃O₄ can recycle the magnetic resin, reduce iron ions in solution and reduce iron sludge after being thrown into reaction.

(2) The present invention employs the joint effect of resin absorption and Fenton oxidation; the best effect can be reached when pH is controlled within 5˜7, thereby reducing the use of acid reagent and the cost.

(3) Through the coupling process of absorption-advanced oxidation-absorption-disinfection, the present invention can effectively remove the organic matters hard to be degraded and impair the toxicity, meeting the quality standard of reuse water and requirement for security;

(4) The present invention employing the joint disinfection of ultraviolet and chlorine can both kill pathogen in the water and effectively remove the organic pollutants again through various effects such as hydroxyl radicals, chlorine free radicals and hypochlorous acid oxidation, reducing the water toxicity and ensuring ecological security of reuse water;

(5) The process of absorption-advanced oxidation-absorption-disinfection provided by the present invention operates stably, is easy to manipulate, and offers highlevel effluent with stable and secure water quality.

### DETAILED DESCRIPTION

In order to make the objectives and advantages of the present invention more apparent, the present invention will be described in detail with reference to the following embodiments. It should be understood that the following words are only the description of one or more specific embodiments of the present invention, not a serious limitation for the protection claimed by the present invention.

The method for advanced treatment and reuse of biochemical effluent from chemical wastewater is a coupling process of resin absorption, Fenton advanced oxidation and UV-chlorine disinfection, which enriches the refractory organic matters in the biochemical effluent from chemical wastewater through resin absorption, and adds H₂O₂ for Fenton advanced oxidation decomposition under catalysis of Fe₃O₄ nanoparticles, then removes parts of decomposition products through resin absorption and further removes the organic substances remained in solution through UV-chlorine disinfection.

### Embodiment 1

After adjusting pH value of the biochemical effluent of a large chemical wastewater treatment plant to 6, adding magnetic resin and H₂O₂ successively, the volume of the magnetic resin accounting for 2% in the biochemical effluent from chemical wastewater, the concentration of H₂O₂ being 4 mmol/L, and separating solid from liquid after 300 minutes' reaction. Adding NaClO disinfectant of 5 mg/L by Cl₂ into the separated biochemical effluent from chemical wastewater, while opening UV lamp of 30 W for 600 seconds, the water quality of the effluent is shown in Table 1. Finally, mixing the separated magnetic resin with 5 wt. % sodium hydroxide (NaOH), 70 wt. % methanol (CH₃OH) for regeneration, the regeneration time being 130 minutes, then standing for 55 minutes; using the regenerated magnetic resin as a fresh magnetic resin. As shown in Table 1, with reference to the water quality standard for washing water in the reuse of urban recycling water—Water quality standard for industrial uses (GB/T19923-2005), the waste water of this plant meets the reuse standard of recycled water.

TABLE 1
Comparison of effluent water quality from the
method in the present invention with the water
quality standard for washing water

| | | | | soluble | | |
|---|---|---|---|---|---|---|
| | | | | total | residual | fecal |
| | TOC | COD_{Cr} | BOD₅ | solid | chlorine | coliforms |
| index | (mg/L) | (mg/L) | (mg/L) | (mg/L) | (mg/L) | (cells/L) |
| effluent from | 7.8 | 20.2 | 10.8 | 500 | 0.3 | 10 |
| the method | | | | | | |
| for the | | | | | | |
| present | | | | | | |
| invention | | | | | | |
| washing water | — | — | ≦30 | ≦1000 | ≧0.05 | ≦2000 |
| standard for | | | | | | |
| water quality | | | | | | |

### Embodiment 2

After adjusting pH value of the biochemical effluent of a large chemical wastewater treatment plant to 5, adding magnetic resin and H₂O₂ successively, the volume of the magnetic resin accounting for 1.5% in the biochemical effluent from chemical wastewater, the concentration of H₂O₂ being 3 mmol/L, and separating solid from liquid after 100 minutes' reaction. Adding NaClO disinfectant of 5 mg/L by Cl₂ into the separated biochemical effluent from chemical wastewater, while opening UV lamp of 30 W for 120 seconds, the water quality of the effluent is shown in Table 2. Finally, mixing the separated magnetic resin with 15 wt. % sodium hydroxide (NaOH), 20 wt. % methanol (CH3OH) for regeneration, the regeneration time being 60 minutes, then standing for 60 minutes; using the regenerated magnetic resin as a fresh magnetic resin. As shown in Table 2, with reference to the water quality standard for boiler supply water in the reuse of urban recycling water—Water quality standard for industrial uses (GB/T19923-2005), the waste water of this plant meets the reuse standard of recycled water.

TABLE 2
Comparison of effluent water quality from the
method in the present invention with the water
quality standard for boiler supply water

| | | | | soluble | | |
|---|---|---|---|---|---|---|
| | | | | total | residual | fecal |
| | TOC | COD_{Cr} | BOD₅ | solid | chlorine | coliforms |
| index | (mg/L) | (mg/L) | (mg/L) | (mg/L) | (mg/L) | (cells/L) |
| effluent from | 5.9 | 18.3 | 7.1 | 500 | 0.5 | 24 |
| the method | | | | | | |
| for the | | | | | | |
| present | | | | | | |
| invention | | | | | | |
| boiler supply | — | ≦60 | ≦10 | ≦1000 | ≧0.05 | ≦2000 |
| water | | | | | | |
| standard for | | | | | | |
| water quality | | | | | | |

### Embodiment 3

After adjusting pH value of the biochemical effluent of a large chemical wastewater treatment plant to 7, adding magnetic resin and H₂O₂ successively, the volume of the magnetic resin accounting for 3% in the biochemical effluent from chemical wastewater, the concentration of H₂O₂ being 5 mmol/L, and separating solid from liquid after 550 minutes' reaction. Adding NaClO disinfectant of 5 mg/L by Cl₂ into the separated biochemical effluent from chemical wastewater, while opening UV lamp of 30 W for 1800 seconds, the water quality of the effluent is shown in Table 3. Finally, mixing the separated magnetic resin with 10 wt. % sodium hydroxide (NaOH), 50 wt. % methanol (CH3OH) for regeneration, the regeneration time being 100 minutes, then standing for 65 minutes; using the regenerated magnetic resin as a fresh magnetic resin. As shown in Table 3, with reference to the water quality standard for process and product water in the reuse of urban recycling water—Water quality standard for industrial uses (GB/T19923-2005), the waste water of this plant meets the reuse standard of recycled water.

TABLE 3
Comparison of effluent water quality from the method
in the present invention with the water
quality standard for process and product water

| | | | | soluble | | |
|---|---|---|---|---|---|---|
| | | | | total | residual | fecal |
| | TOC | COD_{Cr} | BOD₅ | solid | chlorine | coliforms |
| index | (mg/L) | (mg/L) | (mg/L) | (mg/L) | (mg/L) | (cells/L) |
| effluent from | 9.2 | 22.3 | 11.4 | 850 | 0.5 | 18 |
| the method | | | | | | |
| for the | | | | | | |
| present | | | | | | |
| invention | | | | | | |
| process and | — | ≦60 | ≦10 | ≦1000 | ≧0.05 | ≦2000 |
| product water | | | | | | |
| standard for | | | | | | |
| water quality | | | | | | |

To sum up, the method for advanced treatment and reuse of biochemical effluent from chemical wastewater provided by the present invention can, on one hand, effectively enriches the pollutants through absorption by utilizing its higher specific surface area; on the other hand, facilitate Fenton oxidation decomposition by rendering Fe₃O₄ loaded therein as catalyst and can also remove the decomposition products through the magnetic resin by absorption. At the same time, adding additional UV source and chlorine strengthens its oxidation process, and functions as disinfection to kill pathogen, so that the water reuse can be further achieved.

The implementation of the present invention has been described in detail by above embodiments, but to which the present invention is not limited, for those skilled in the art, after being informed of the description in the present invention, several equivalent modifications and substitutions can be made without departing from the principle of the present invention, these equivalent modifications and substitutions should also be considered as falling within the scope of the present invention.

What is claimed is:

1. A method for advanced treatment and reuse of biochemical effluent from chemical wastewater, characterized by comprising following steps:
(1) preparing a highly-loaded Fe₃O₄ magnetic resin by spray suspension polymerization;
(2) using the magnetic resin prepared in Step (1) for advanced treatment of the biochemical effluent from chemical wastewater and adding 3˜5 mmol/L H₂O₂ into the biochemical effluent from chemical wastewater for a mixed reaction of 60˜600 minutes;
(3) separating solid from liquid firstly in the mixed wastewater after being treated in Step (2), and then disinfecting the separated biochemical effluent from chemical wastewater.

2. The method for advanced treatment and reuse of biochemical effluent from chemical wastewater according to claim 1, characterized in that: the volume ratio of the magnetic resin and the biochemical effluent from chemical wastewater is 0.1%˜5%.

3. The method for advanced treatment and reuse of biochemical effluent from chemical wastewater according to claim 1, characterized in that: the specific surface area of the magnetic resin is 500˜700 m²/g, the mass fraction of Fe₃O₄ nanoparticles in the magnetic resin is 30%˜50%.

4. The method for advanced treatment and reuse of biochemical effluent from chemical wastewater according to claim 2, characterized in that: the magnetic resin is prepared by using a nozzle with aperture of 20˜50 μm to disperse uniformly a mixed solution of an oil phase and Fe₃O₄ nanoparticles into a water phase under 0.1 MPa to form an emulsion, heating up to 70° C. for 2 hours' reaction at a stirring speed of 150 r/min and then heating up to 85° C. for 12 hours' reaction, subsequently using deionized water, ethanol, acetone to wash, and finally drying.

5. The method for advanced treatment and reuse of biochemical effluent from chemical wastewater according to claim 3, characterized in that: in the oil phase, a monomer is divinylbenzene, a porogen is toluene and an initiator is azobisisobutyronitrile, the ratio of divinylbenzene and toluene is 1:2˜1:3 and the mass fraction of azobisisobutyronitrile is 1%.

6. The method for advanced treatment and reuse of biochemical effluent from chemical wastewater according to claim 3, characterized in that: in the water phase, a dispersant is sodium dodecyl sulfate and polyvinylpyrrolidone, and the ratio of sodium dodecyl sulfate and polyvinylpyrrolidone is 1:3˜1:6, the mass fraction of the dispersant is 0.5%˜2%.

7. The method for advanced treatment and reuse of biochemical effluent from chemical wastewater according to claim 3, characterized in that: the Fe₃O₄ nanoparticles is oleic-coated modified, the mass ratio of the Fe₃O₄ nanoparticles and the oil phase is 1:1˜1:2.

8. The method for advanced treatment and reuse of biochemical effluent from chemical wastewater according to claim 1, characterized in that: in the advanced treatment process, the pH value of the mixed wastewater is adjusted to 5˜7 by using hydrochloric acid and sodium hydroxide.

9. The method for advanced treatment and reuse of biochemical effluent from chemical wastewater according to claim 1, characterized in that: the disinfection is UV and chlorine combined disinfection, being a ultraviolet light and a NaClO disinfectant; the amount of the NaClO disinfectant is 5 mg/L in terms of Cl₂, the ultraviolet light with low pressure mercury lamp as light resource has a UV radiation intensity of 30 W and reaction time of 100˜1800 seconds.

10. The method for advanced treatment and reuse of biochemical effluent from chemical wastewater according to claim 1, characterized in that: it further comprises mixing the magnetic resin resulted from separation in Step (3) with a recycled liquid, which is composed of 5 wt. %˜15 wt. % sodium hydroxide (NaOH), 20 wt. %˜70 wt. % methanol (CH₃OH) or 5 wt. %˜15 wt. % NaOH, 50 wt. % CH₃OH, after mixing the magnetic resin with the recycled liquid for 20˜180 minutes, standing for 55˜65 minutes to separate the magnetic resin for recycling.
